(19) United States
(12) Patent Application Publication
(10) Pub. No.: US 2011/0168838 A1
(43) Pub. Date: Jul. 14, 2011

(54) Launch tube deployable surveillance and reconnaissance system

(75) Inventors: William Hornback, Homeland, CA (US); Michael Holly, Estero, FL (US)

(73) Assignee: Irvine Sensors Corporation, Costa Mesa, CA (US)

(21) Appl. No.: 12/799,297

(22) Filed: Apr. 21, 2010

Related U.S. Application Data
(60) Provisional application No. 61/214,812, filed on Apr. 27, 2009.

(51) Int. Cl. B64F 1/04

(52) U.S. Cl. 244/63

(57) ABSTRACT

An unmanned aerial surveillance and reconnaissance system are disclosed wherein an unmanned aerial vehicle is launchable from a launch tube, for instance, the bore of an existing weapons system mounted on a mobile vehicle, such as a weapon barrel of a tank or armored combat vehicle and which the launch may be remotely initiated from the protected armored compartment of the mobile vehicle.

### CROSS-REFERENCE TO RELATED APPLICATIONS

This application claims the benefit of U.S. Provisional Patent Application No. 61/214,812, filed on Apr. 27, 2009 entitled “Weapon-Bore Launched Unmanned Aerial System and Device for Launching Same” pursuant to 35 USC 119, which application is incorporated fully herein by reference.

### STATEMENT REGARDING FEDERALLY SPONSORED RESEARCH AND DEVELOPMENT

N/A

### DESCRIPTION

1. Field of the Invention

The invention relates generally to the field of unmanned aerial systems. More specifically, the invention relates to an unmanned aerial surveillance and reconnaissance system and vehicle that is launchable from, for instance, the bore of a separately provided existing weapons system mounted on a mobile vehicle and which launch may be remotely initiated from an armored compartment of the mobile vehicle.

2. Background of the Invention

Current military surveillance and reconnaissance efforts rely heavily on unmanned aerial vehicles and unmanned aerial systems (i.e., UAVs and UASs respectively) for a variety of missions. Such missions include threat identification and assessment, identifying locations of enemy combatants and enemy materiel, damage analysis, rescue and mapping and coordinating military operations in unfamiliar territory.

Current aerial vehicle launch systems typically require that the UAS operator physically enter the combat environment to launch the UAV thus exposing the operator to enemy fire, toxic substances, blast injury or other combat threats.

What is needed is a system that allows a user to launch a small (usually less than five pounds and a wing span of less than four feet) UAV or UAS from the safety of a mobile vehicle such as the armored personnel compartment of a combat vehicle without the need of exposing the operator to enemy fire.

The instant invention addresses the above deficiencies in existing UAS launch systems and can also take advantage of an existing weapons launch tube mounted on a combat or other vehicle.

### SUMMARY OF THE INVENTION

An unmanned aerial surveillance and reconnaissance launch system is disclosed wherein an unmanned aerial vehicle is launchable from, for instance, the bore of an existing weapons system mounted on a mobile vehicle such as the weapon barrel of a tank or armored combat vehicle and which launch may be remotely initiated from the protected armored compartment of the mobile vehicle. For purposes of clarity, the term UAV refers to the aerial vehicle and UAS refers to the complete system including launcher, ground controller and communications subsystems.

The wings of the unmanned aerial vehicle of the invention are selectively deformable whereby the wings may be folded from a first outwardly projecting orientation to a folded second orientation so as to allow the unmanned aerial vehicle to be disposed within the bore of a tube such as the weapon bore of a tank or armored combat vehicle.

Propulsion means is provided that is disposed within the bore for the propulsion of the aerial vehicle longitudinally along the length of the bore and out of the muzzle into the operating environment. The initiation of the launch of the aerial vehicle desirably occurs from within the enclosed armored compartment of the vehicle where the operator is not exposed to combat threats such as small arms fire.

### BRIEF DESCRIPTION OF THE DRAWINGS

FIG. 1 shows a mobile vehicle having a bore for launching an unmanned aerial vehicle.

FIGS. 2 and 3 illustrate the unmanned aerial vehicle of the invention and having deformable wings disposed in a first orientation and a second orientation respectively.

FIG. 4 depicts a plurality of bores for the receiving of the unmanned aerial vehicle of the invention wherein one of the bores depicts an unmanned aerial vehicle disposed therein.

FIG. 5 is a top view of the propeller of the unmanned aerial vehicle of the invention in the retracted and flight position.

FIGS. 6, 7 and 8 are side views of the aerial vehicle and propulsion means during three points in a launch cycle.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE INVENTION

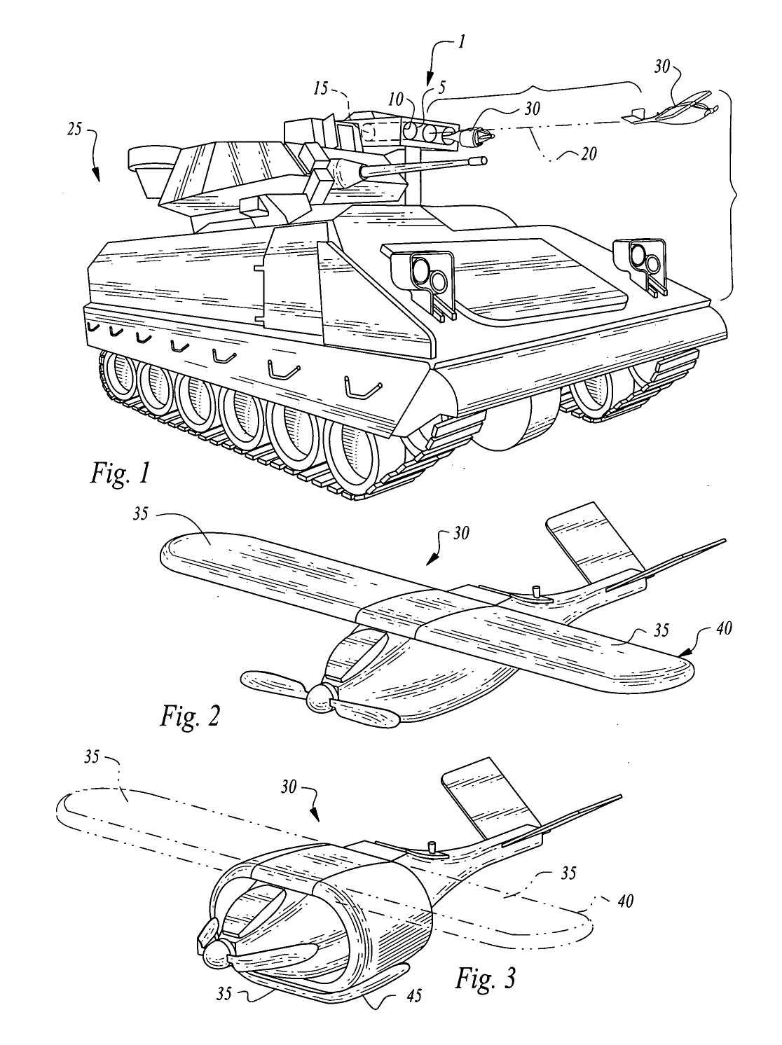

Turning now to the figures wherein like numerals define like elements among the several views, FIG. 1 depicts a preferred embodiment of the invention comprising a launch tube system 1 comprising a barrel 5 having a bore aperture 10 and a bore 15 having a longitudinal axis 20.

Launch tube system 1 is mounted on a mobile vehicle 25, in this embodiment, an armored combat vehicle such as a Stryker vehicle, Bradley fighting vehicle, tank or the like. In the depicted embodiment, the launch tube system is a TOW missile system (i.e., tube-launched, optically-tracked, wire data link, guided missile). By way of example and not by limitation, mobile vehicle 25 may be any mobile vehicle system such as a jeep, Humvee, armored personnel carrier, watercraft, amphibious craft or airborne vehicle such as a helicopter.

The invention further comprises an unmanned aerial vehicle (“UAV” herein) such as a remotely-operated, self-propelled aerial vehicle having suitable electronics for a user-defined task or tasks such as, by way of example and not by limitation, thermal or visible imaging means, imaging data recording and transmission means, fused imaging means, LADAR imaging means, sensor data collection and recording means (e.g., temperature, speed, humidity, altitude, acceleration etc.) using a user-defined set of sensors and support electronics.

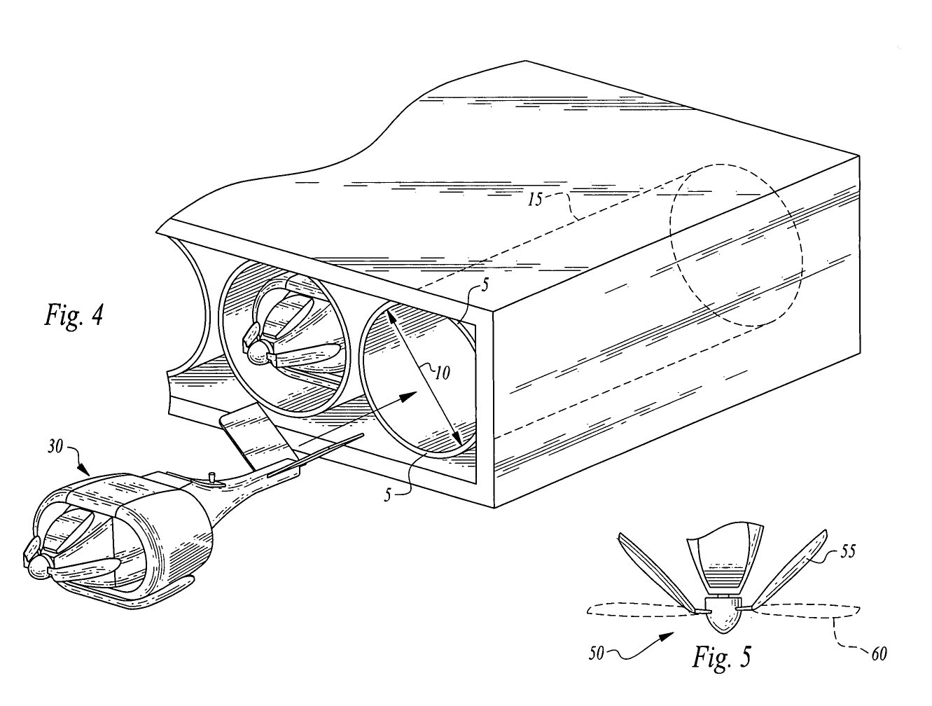

As better seen in FIGS. 2-6, UAV 30 is adaptable so as to be received within bore 15 of barrel 5 of launch tube system 1. Bore 15 may comprise the barrel of an existing weapons launch system such as missile launch or guided missile launch system, the barrel of a weapons launch system on a tank, the barrel of a weapons launch system on a Bradley fighting vehicle, the barrel of a weapons launch system on a Stryker vehicle or a similar weapons launch system.

In addition, barrel 5 and bore 15 may comprise a separately attached launch tube mounted to the exterior of a mobile vehicle 25.

In the embodiment shown, UAV 30 is comprised of at least one deformable wing element 35 having a first orientation 40 (i.e., flight orientation) and a second orientation 45 (i.e., bore orientation). As is seen, wing elements 35 are foldable so as to be disposed within bore 15. In a preferred embodiment, wing element 35 is comprised of a flexible carbon fiber material or other flexible material that is “foldable” or bendable about the body, fuselage or payload of the UAV.

The wing element 35 is preferably fabricated from a material that has a “memory” whereby when folded wing elements 35 are disposed in second orientation 45 and are subsequently unrestricted by the inner diameter of bore 15, (i.e., when the UAV exits bore aperture 10), wing elements 35 will snap or reorient back to first orientation 40 for flight.

In the illustrated embodiment of FIG. 5, propeller 50 of UAV 30 has a retracted position 55 for disposition within bore 15 and a flight position 60 for flight.

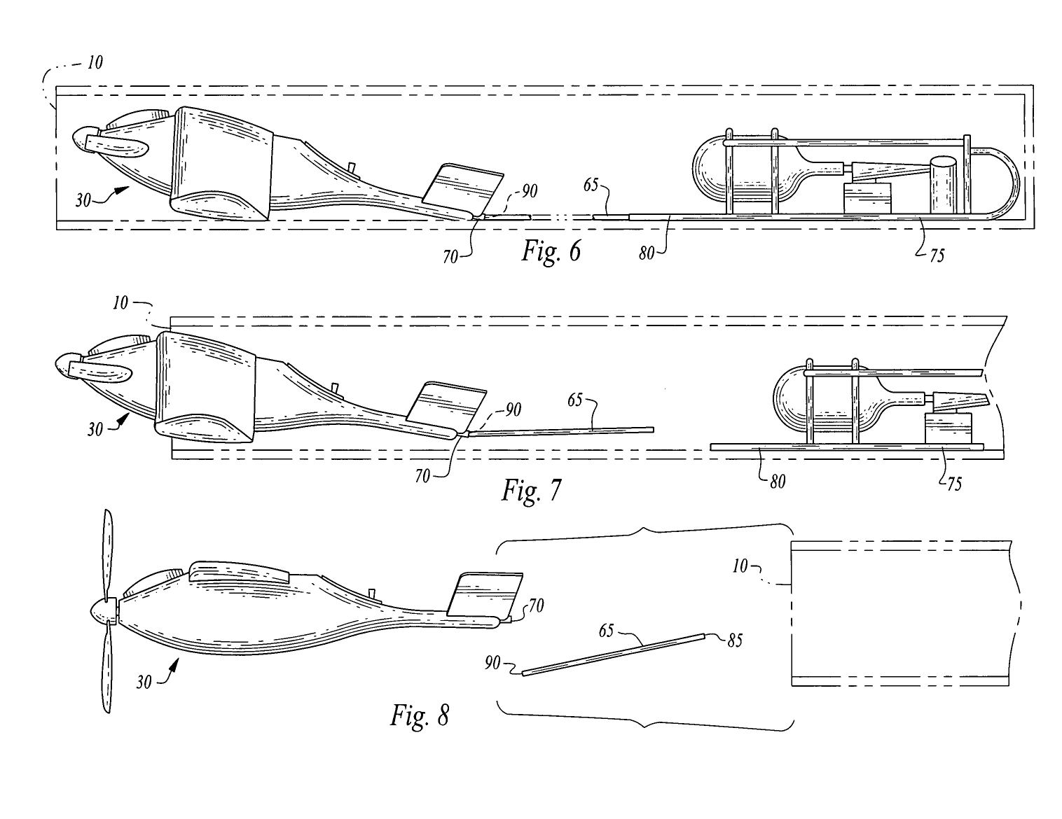

Turning now to FIGS. 6-8, a time sequenced set of side cutaway views is shown, reflecting the launch of UAV 30 from bore 15.

In the illustrated embodiment of FIG. 6, UAV 30 is mounted to a detachable slide member 65. Slide member 65 is detachably received on the tail portion 70 of UAV 30 as is discussed further below.

The invention further comprises propulsion means 75 which may be any suitable propulsion means whereby UAV 30 is urged forward along longitudinal axis 20 of bore 15 and projected toward and out of bore aperture 10 at a predetermined velocity. Upon exiting bore aperture 10, wing elements snap back and reorient to first orientation 40.

Propulsion means 75 is provided so as to be received within bore 15 and may be comprised of any suitable means for urging UAV 30 toward and out of bore aperture 10 such as expansion of a compressed gas, a tension or compression means such as a spring element or assembly, or oxidizing or combustion means such as a combustible material. It is expressly noted that propulsion means 75 need not be separately provided and may be integrated as a component of the UAV itself.

In the illustrated embodiment, slide tube member 80 receives first terminal end 85 of slide member 65. Second terminal end 90 of slide member 65 is detachably received by tail portion 70. Second terminal end 90 is in fluid communication with propulsion means 75 by means of a quick release valve (not shown) that is preferably remotely activated by a user. The user can selectively initiate the launch of UAV 30 from a location physically separated from the environment to which bore aperture 10 is exposed (e.g., a combat environment), such as a substantially enclosed, and preferably armored, operator compartment of a combat vehicle.

The operation of the preferred embodiment of the disclosed invention is as follows. Propulsion means 75 is detachably connected to UAV 30 at tail portion 70 via second terminal end 90 of slide member 65. For instance, second terminal end 90 may be received by tail portion 70 within a recess defined on tail portion 70 whereby upon exiting bore aperture 10, slide member 65 falls away from UAV 30.

Deformable wings 35 are folded or bent downwardly and inwardly about the body of UAV 30 as reflected in FIG. 7 and the UAV/propulsion means assembly is disposed within bore 15 of barrel 5.

In a preferred embodiment, the launch of UAV 30 is initiated remotely using a wireless connection (e.g., laptop or controller in electronic communication with launch initiation electronics comprised as part of propulsion means 75).

By way of example and not by limitation, launch initiation means may comprise a mechanical means such as a mechanical trigger assembly or electronic means such as hardwired or wireless electronic means.

As seen in FIG. 7, after the launch is initiated, the rapid expansion of the compressed gas of propulsion means 75 urges slide member 65 forwardly and along the internal bore length of slide tube member 80 much like a piston in a cylinder, urging UAV 30 along longitudinal axis 20 of bore 15 at a predetermined acceleration and velocity.

Both slide member 65 and UAV are projected out of bore aperture 10 at which point wing elements 35 return from second orientation 45 to first orientation 40 and slide member 65 disengages from slide tube member 80 and tail portion 70.

Propeller 50 is then powered up using suitable control electronics and returns from retracted position 55 to flight position 60 such that UAV 30 is launched and flies under its own power and control by the operator.

Alternative embodiments for initiating a launch include electrical or mechanical timing means to initiate a launch at a predetermined time or by using a predetermined GPS coordinate programmed to launch when mobile vehicle 25 arrives at a predetermined location.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the invention.

We claim:

1. A launch tube deployable surveillance and reconnaissance system comprising:
a launch tube comprising a barrel,
the barrel further comprising a bore having a longitudinal axis and a muzzle aperture,
an aerial vehicle comprising at least one deformable wing element and adapted to be received within the bore, and,
an aerial vehicle propulsion means adapted to be received within the bore and adapted to propel the aerial vehicle substantially along the longitudinal axis through the muzzle aperture.

2. The system of claim 1 wherein the wing element may be selectively deformed from a first orientation to a second orientation so as to be received within the bore and wherein the wing element returns to the first orientation subsequent to passing through the muzzle aperture.

3. The system of claim 1 wherein the propulsion means is comprised of the expansion of a compressed gas.

4. The system of claim 1 wherein the wing element is comprised of a flexible material.

5. The system of claim 1 wherein the launch tube is an element of an existing missile system.

6. The system of claim 1 wherein the launch tube is an element of an existing guided missile system.

7. The system of claim 1 wherein the launch tube is mounted on a mobile vehicle having a substantially enclosed operator compartment.

8. The system of claim 7 wherein the mobile vehicle further comprise the barrel of a weapons launch system.

9. A method for converting an existing weapons launch system to an aerial vehicle launch system comprising the steps of:
providing a weapons launch system comprising a barrel having a bore having a longitudinal axis and a muzzle aperture,
providing an aerial vehicle comprising at least one deformable wing element whereby the aerial vehicle may be selectively adapted to be received within the bore,
providing propulsion means adapted to be received within the bore for propulsion of the aerial vehicle substantially along the longitudinal axis through the muzzle aperture, and,
disposing the propulsion means and aerial vehicle within the bore.

10. The method of claim 9 wherein the wing element may be selectively deformed to a second orientation while received within the bore and wherein the wing element returns to a first orientation subsequent to passing through the bore.

11. The method of claim 9 wherein the propulsion means is comprised of the expansion of a compressed gas.

12. The method of claim 9 wherein the propulsion means is comprised of a spring element.

13. The method of claim 9 wherein the propulsion means is comprised of a compression element.

14. The method of claim 9 wherein the propulsion means is comprised of a tension element.

15. The method of claim 9 wherein the propulsion means is comprised of a combustion means.

16. The method of claim 9 wherein the wing element is comprised of a flexible material.

17. The method of claim 9 wherein the existing weapons launch system is comprised of a missile system.

18. The method of claim 9 wherein the existing weapons launch system is comprised of a guided missile system.

19. The method of claim 9 wherein the existing weapons launch system is mounted on a mobile vehicle having a substantially enclosed operator compartment.
